(19) United States
(12) Patent Application Publication
(10) Pub. No.: US 2009/0249179 A1
(43) Pub. Date: Oct. 1, 2009

(54) METHOD TO DISPLAY MULTIPLE CACHED WEBPAGES RELATED TO A BOOKMARK

(76) Inventors: Johnny M. Shieh, Austin, TX (US); Gerald F. McBrearty, Austin, TX (US)

Correspondence Address: PATENTEC, 2001 JEFFERSON DAVIS HWY #301, ARLINGTON, VA, 22202, US

(21) Appl. No.: 12/057,868

(22) Filed: Mar. 28, 2008

(51) Int. Cl. G06F 17/00

(52) U.S. Cl. 715/206

(57) ABSTRACT

A method for displaying cached webpages related to bookmarks in a browser program. Displayed along with selected bookmarks in the bookmark menu is a numeral indicating the present total number of cached webpages associated with the bookmarks. When the user selects the numeral, a number count menu is displayed allowing the user to select a cache-count number indicating the desired number of cached webpages to display. Upon selection of the cache-count number, the corresponding number of webpages are displayed in reduced resolution. These webpages may then be further selected by the user to requery or renavigate to the webpages.

### FIELD OF THE INVENTION

This invention relates generally to the field of computer browser programs, and in particular to browsers that store cached copies of previously viewed webpages and provide shortcuts for navigating to previously visited URLs.

### BACKGROUND OF THE INVENTION

The access of information through the Internet or private networks is often carried out using computer browser software. A user wishing to access information can specify the desired information by a number of methods, such as by entering a Uniform Resource Locator (URL), by selection of hypertext links within a displayed document, or by choosing a selectable link provided within the browser itself.

One form of selectable link in a browser is commonly known as a “bookmark” (also referred to as a “favorite” or “alias”). A user expecting to access a currently-displayed webpage at a future date selects the bookmarking function within the browser. The browser then creates a selectable link that points to the currently displayed webpage, and adds the link to a bookmark list, as shown in FIG. 1. The bookmarked webpage can then be retrieved in the future by locating the bookmark within the list maintained by the browser, and then by selecting the bookmark to initiate retrieval of the document. The bookmark is often designated within the list by a descriptive name instead of the actual URL.

When a website includes several related documents or webpages, all interconnected by links or other selectable data, the user typically only bookmarks one main (also known as: “root”, “anchor” or “index”) webpage. By bookmarking only a single webpage instead of separate webpages for the entire website, the size of the bookmark list is kept manageable. The additional related webpages that are interlinked from the main bookmarked page usually have URLs that begin with the same character string, with only the tail end containing unique characters corresponding to further navigation.

But the prior method of bookmarking only the main webpage can have disadvantages, especially for websites having a large number of navigable webpages all derived from the same main webpage, such as may happen for an index page, a webpage containing a menu of links, or a search page requiring entry of search terms. For these more complicated websites, it is quite possible for the user to forget the series of choices in the navigation route that allowed access to desired information starting from the main webpage. Should the user wish to retrieve the information again, the user must then duplicate the choices that led to the original retrieval. In trying to reconstruct the paths, the user may make mistakes or take a different, longer navigation path. If there is any delay in linking to webpages at the information source, this means that the user must incur those delays again. This makes mistakes and longer navigation paths worse.

To avoid this problem, browsers commonly include several features to assist the user in repeating previous navigation paths. For example, browsers can designate previously visited links with a different color than unvisited links. Thus, a user wishing to locate previously viewed information may click on a bookmark list, find a bookmark on the list, click on that bookmark, and then continue following the navigation “trail”. This tool is helpful when the user has explored only one or few of the links within each webpage leading to the desired information. But it has limited usefulness where several links have been followed or where the resulting information is generated by search terms. Since each webpage in the sequence must be successfully loaded before linking to the next, delays for each webpage along the path will add up to cause large delays at arriving at the desired ultimate information. There are also additional delays such as for loading webpages in mistaken paths and then retracing, or for repeating searches with search terms possibly different from the previous time.

Browsers also commonly include a “history” feature wherein a record is kept of previous web pages accessed. A user wishing to locate a previously viewed webpage may then review a list of those webpages from the history, and select a web page in the list based on a memory of the page name and time of access. This tool is helpful so long as the user remembers the previous page name and access time, or if there are few pages in the history that could correspond to the information sought. But it has only limited usefulness where several pages exist in the history that could correspond to the desired information, or where the resulting information is generated by search terms. Also, delays still occur, for loading the desired pages, for loading mistaken pages, for locating search pages, and for repeating searches with possibly mistaken search terms.

As an additional method to speed access of previously accessed websites, browsers commonly include a cache wherein a copy of an accessed webpage is saved in storage at the user's computer. Document caching rules are specified by protocols such as HTTP 1.0 and higher, or by settings in the browser. Cached webpages may include the results of search queries.

In managing the cached webpages, the browser may check the webpages for freshness, while deleting older cached pages. Cached webpages are especially helpful for accessing resources that have long download delays, such as the results of queries. But the cache of webpages, as currently implemented in browsers, is not intended to be directly accessed by users. The cached webpages use hashed names that are non-understandable by the users. In addition, the cached webpages do not aid in more quickly traveling to the desired real webpage. In most cases, the caching operation is entirely invisible to the user. As a result, even though a cached webpage may already exist on the user's computer holding the results of a lengthy query or representing a lengthy navigation path from a root webpage, the user will often recreate the query or re-travel the navigation path in order to reach the same result that was previously stored.

Therefore, a significant need exists for a method for accessing and displaying cached webpages within a browser, without the necessity of requerying or renavigating to the original webpage. A further need exists to easily navigate to a previously viewed webpage, by first displaying a cached copy of the webpage that is readily accessed through a bookmark list.

### SUMMARY OF THE INVENTION

Therefore, the present invention provides a convenient way for a browser to manage a list of bookmarks to enable a user to display cached webpages associated with said bookmarks and to rapidly navigate to previously visited webpages.

According to a preferred embodiment of the invention, when a user selects a bookmark menu within a browser, prior to opening up the menu, the browser compares the URLs corresponding to the bookmark list against the contents of the browser cache, generating a count of cached entries having similar URLs associated with each bookmark. The browser then displays the bookmark list to the user, along with the number of cached webpages as a separately selectable count link.

If the user selects the count link, the browser displays a second menu allowing the user to choose how many of the associated webpages to display: one of the count, all of the count or some number in between. Based on the user's response, the browser then retrieves the picked number of most recent browser cache entries corresponding to the original bookmark link and adapts them for simultaneous display in the main browser window.

According to a further embodiment of the invention, the display window area representing each displayed cache document is also adapted to be a selectable link. When the user selects a display window link, the URL corresponding to that cached entry is specified for retrieval.

The method and operation of an exemplary embodiment of the present invention are described more completely in the detailed drawings and description which follow, and in the claims appended herewith.

### BRIEF DESCRIPTION OF THE DRAWINGS

FIG. 1 is a simplified diagram of a screen display for a browser implementing a bookmark management method according to the prior art.

FIG. 2A is a simplified diagram of a bookmark management display for a browser implementing a cached webpage display method according to an exemplary embodiment of the invention.

FIG. 2B is a simplified diagram of a screen display of the browser of FIG. 1A illustrating a further display presented to the user by the cached webpage display method according to an exemplary embodiment of the invention.

FIGS. 3A-3D are flowcharts illustrating the program flow within the bookmark menu routines for the cached webpage display method of the present invention.

### DETAILED DESCRIPTION

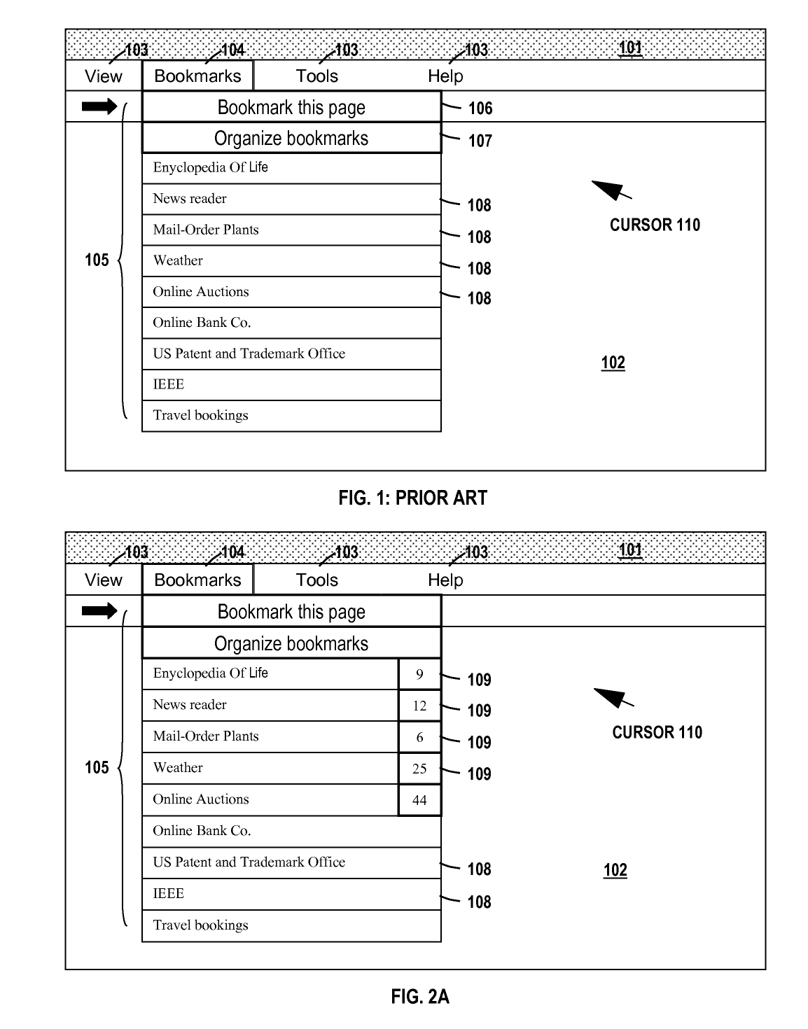

FIG. 1 illustrates a conventional browser program running on a computer system connected to a network that enables retrieval of webpages according to an HTTP protocol or the like, such as the Internet or a local network. The browser includes a document display window 102 and tool bar 101 having miscellaneous primary menu items 103, including a menu item for the bookmark tool 104. The browser generally includes additional toolbars and action buttons (not shown), such as an address box for direct-entry navigation and resizing controls, as is well known in the art.

A user wishing to create new bookmarks for webpages being viewed in main display 102 or wishing to review previously bookmarked webpages, uses a pointing device to position cursor 110 over bookmark menu item 104, and select it. The bookmark menu 105 opens up and displays a choice of actions related to bookmarks. Possible actions include the creation of new bookmarks for webpages being currently viewed in display frame 102 through a bookmark creation button 106 (“Bookmark this page”), organization or editing of previously created bookmarks by selection of an organization button 107 (“Organize bookmarks”), and selection of particular bookmarks 108 as individual action links. As shown in FIG. 1, action links 108 can be presented as link names easily recognized by the user instead of as absolute network addresses. A leading “favicon” or favorite icon (not shown) may be presented along with the link name. As explained above, there are usually multiple webpages associated with the diverse links 108 that the user may desire to visit; but the conventional browser allows the user to navigate to only a single webpage for each action link 108. If additional webpages are needed for each website, they must be stored as additional action links 108, or the user must select a bookmark corresponding to a different webpage at the same website and then navigate through multiple subsequent webpages or search sequences before arriving at the desired webpage.

When the desired webpage corresponds to the results of a search query, the bookmark link may cause the browser to requery the search, thereby causing a large delay before the results are viewable. In some cases, the user may want to review the previous results, such as might be held in the browser's cache, without causing a requery of the search.

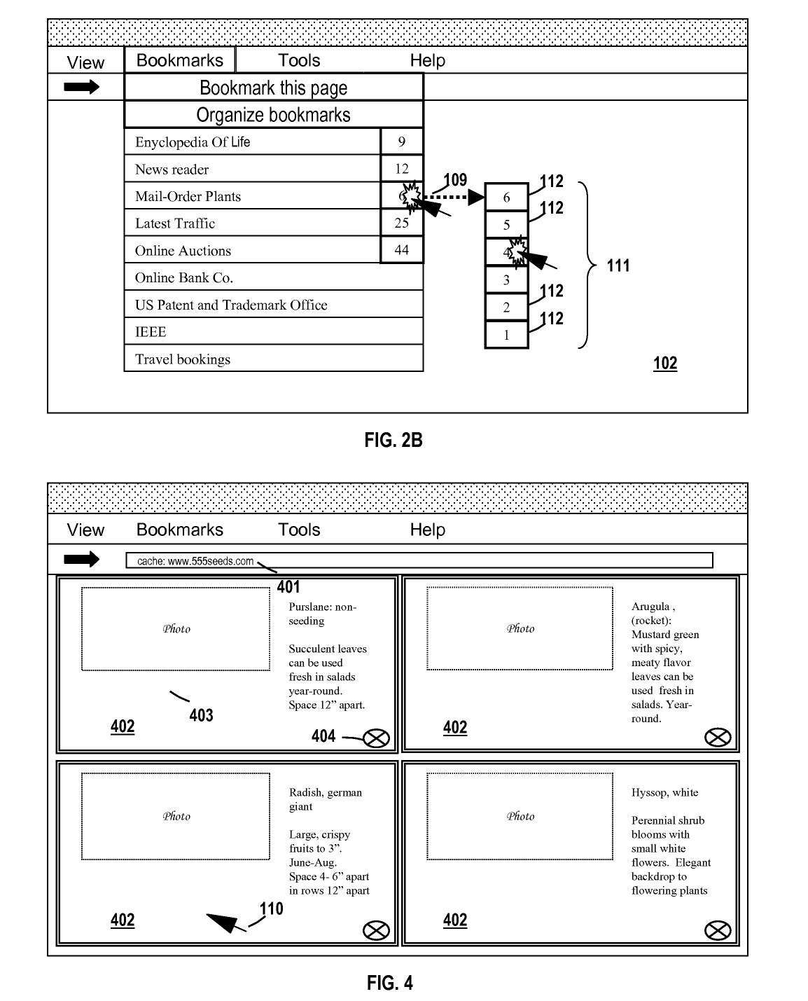

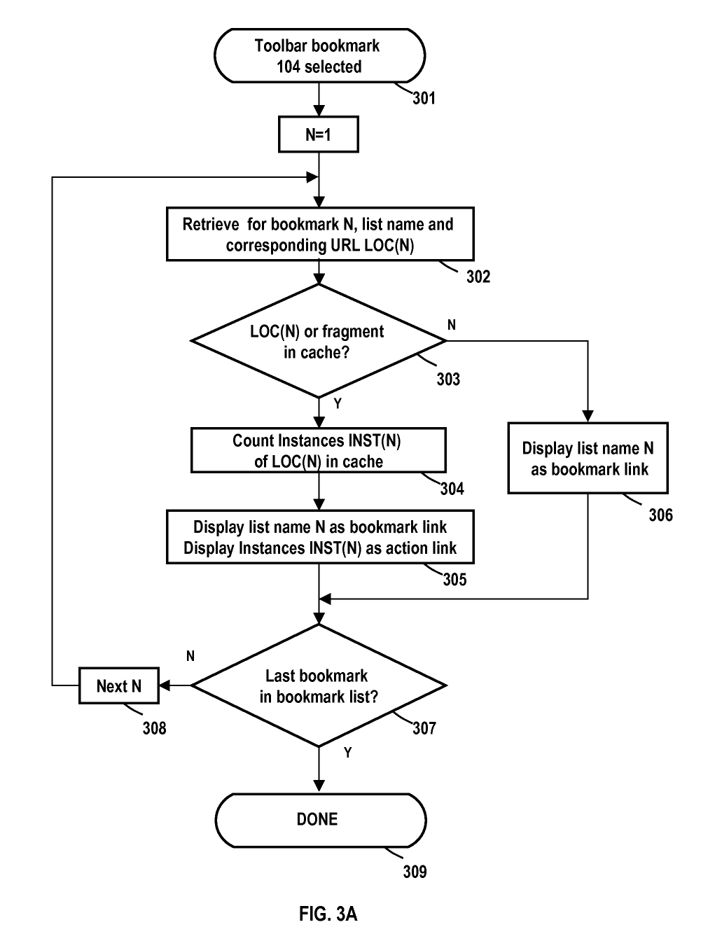

For these reasons, the present invention provides a convenient way to view already cached webpages, and if desired, to navigate to them rapidly. According to an exemplary embodiment of the invention as shown in FIG. 2A, bookmark menu 105 also includes separate cache-count buttons 109 that are displayed alongside some of the bookmark links 108. The cache-count buttons 109 indicate the number of currently cached webpages associated with that link. By clicking on a selected cache-count link 109 as shown in FIG. 2B, Number Choice Menu 111 opens up, displaying a sequence of buttons 112 providing the user with a choice of the number of cached pages to display. After the user clicks on the desired number of pages, a new screen opens up as shown in FIG. 4, including reduced resolution views of the most recently accessed webpages in the cache, according to the desired number of cached webpages selected. Each of these cached webpage views then becomes an action link that may be selected to cause a full resolution view of the cached webpage, or navigation to the desired webpage. The result is a well-organized bookmark list that is automatically maintained, providing a quick way to view cached webpages and to rapidly navigate to them.

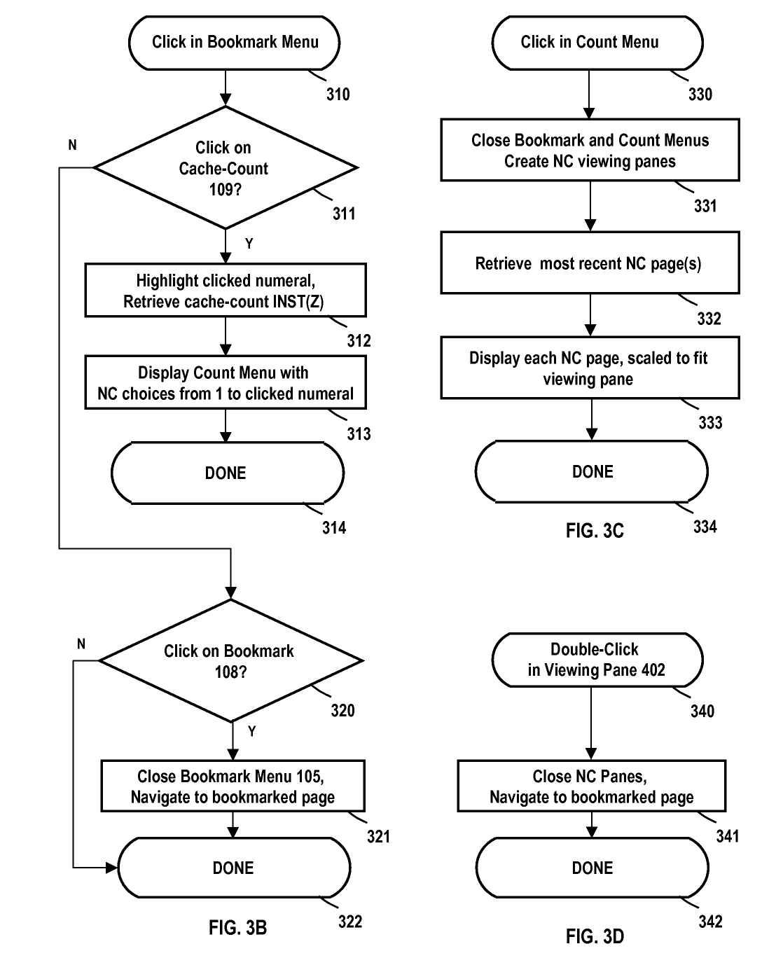

The operation of the present invention may be understood in further detail by considering the exemplary operation shown in the flow charts in FIGS. 3A-3D. While exact methods and formats for handling bookmarks and cached webpages may vary from one computer system to another, the following description is based on a generic computer operating system suitable for illustrating the basic principles of the invention.

When the user selects toolbar bookmark item 104 in FIG. 2A, the browser begins bookmark display routine 301 of FIG. 3A. During the process of displaying the bookmark menu 105 on the computer screen, for each bookmark to be displayed, steps 302-308 are carried out. First, the link name of the desired document is retrieved, 302. Also retrieved is the URL corresponding to the link name, where the URL corresponding to bookmark N in the list designated as LOC(N). Then, the browser examines 303 the cache for any webpages corresponding to LOC(N). In an exemplary embodiment, the browser checks for webpages having the exact URL and for webpages with related URLs, such as would indicate webpages lying within the same website. The related URLs might be determined by matching the left portions of the URL string, keeping in mind that the original bookmark N may have been created to refer to a webpage that is not the root webpage within the navigation hierarchy at the website. In an alternate embodiment the comparison 303 may be carried out on IP addresses instead of named URLs. In this embodiment, at step 302 the browser may be adapted to query a Domain Name Server (DNS) for the IP address corresponding to a bookmarked URL. The browser maintains a count of comparisons deemed successful for a bookmark N, as a count value INST(N), and maintains a list of the corresponding matching URLs.

The name that appears in the bookmark list is then displayed 305 on the computer screen as a clickable link 108 as shown in FIG. 2A. If INST(N) is nonzero, a separate clickable cache count button or link 109 is displayed adjacent to the bookmark link 108. The count INST(N) corresponding to successful browser cache matches of the bookmark N is displayed within the cache count button 109. The browser continues in this fashion until all of the items in the bookmark list have been displayed on the computer screen, and then waits for the user to provide further input.

The response of the browser following a user click within pulldown menu 105 is described with reference to FIG. 3B. If a user clicks on a bookmark link 108, thereby indicating that the user does not wish to review cached webpages, the browser closes bookmark menu 105, retrieves the bookmarked webpage 321 and exits bookmark processing at step 322.

Alternatively, if a user clicks on a cache count button 109 corresponding to a bookmark Z within the list as shown in FIG. 2B, thereby indicating that the user does wish to review cached webpages corresponding to the bookmark Z, then the clicked cache count button 109 is preferably highlighted or otherwise marked 312, the cache count INST(Z) is retrieved 312, and a second pulldown menu 111, 313 is created adjacent to the entry corresponding to bookmark Z within pulldown menu 105. The menu 111 consists of selectable links labeled with number choices from 1 to INST(Z). For the case shown in FIG. 1B, INST(Z) is 6, and choices from 1 to 6 are shown. If INST(Z) is an unpractically high number, so that a menu 111 containing all choices from 1 to INST(Z) would be difficult to position within the display area 102, the number of choices shown within pulldown menu 111 may be limited to a desired number. This top number may be set to the user's preference, and may vary with the screen or window size of the display area 102 as will be further discussed. The browser then waits for further user action, 314.

A user click on a number choice NC 330 confirms that the user wishes to review cached webpages, and instructs the browser how many of the more recent webpages to display. The browser then divides 331 the browser display area 102 into NC viewing panes 402, as shown in FIG. 4, according to the number selected in 330. In a preferred embodiment, each of the NC viewing panes includes standard window control buttons, such as closing control 402 to close the pane. The arrangement of the NC displays may vary according to settings in the browser. For example, the NC displays may be stacked as a cascade instead of paneled as independent panes, as is well-known in the art of windows-type operating systems. The browser may also display the root webpage 401 for which all of the displayed cached webpages are related.

The browser examines the freshness of the cached webpages corresponding to bookmark Z, and selects the most recent NC cached webpages 332. Each selected cached document is scaled to fit within one viewing pane of NC viewing panes displayed in display area 102, and the scaled cached document is drawn onto the viewing pane. The main area of each viewing pane 402 may be designated as an action link. When selected by the user with the cursor 110, the browser may, upon a single click, highlight the selected NC pane and change the displayed URL 401 to the URL corresponding to the selected NC webpage; or may switch to a full-resolution view of the selected cached webpage; or upon a double click 340 in FIG. 3D, close the display of NC panes and navigate to the webpage corresponding to the URL of the double-clicked NC pane. If the displayed NC page corresponds to the result of a search query, the browser may navigate to the search page and requery or repost the search request.

From the foregoing description of the exemplary embodiments, it can be seen that the present invention provides a convenient way to manage a list of bookmarks, to view previously cached webpages, and to navigate to them. Because other modifications may be made to the embodiments described herein without departing from the spirit and scope of the invention, the invention should be limited only by the claims appended herewith.

1. In a computer browser maintaining a list of bookmarks and capable of displaying webpages in a browser window, a method to display at least one cached webpage related to at least one of said bookmarks; said method comprising:
displaying said at least one bookmark within a bookmark menu;
associating said at least one cached webpage with said at least one bookmark;
calculating the number of currently cached webpages having common URL root as said at least one cached webpage;
displaying indicia alongside said at least one bookmark indicating the total number of cached webpages having common URL root as said at least one cached webpage;
upon selection of said indicia by a user, displaying a number count menu including at least one cache-count number indicating the number of desired cached webpages that are to be displayed within the browser window; and
upon selection of said cache-count number by the user, displaying a plurality of cached webpages corresponding to the cache-count number of webpages selected by the user.
